(19) United States
(12) Patent Application Publication
(10) Pub. No.: US 2026/0238908 A1
(43) Pub. Date: Aug. 13, 2026

(54) ACOUSTIC OUTPUT DEVICES

(71) Applicant: SHENZHEN SHOKZ CO., LTD., Shenzhen (CN)

(72) Inventors: Lei ZHONG, Shenzhen (CN); Lei ZHANG, Shenzhen (CN); Shuailin XIE, Shenzhen (CN); Xin QI, Shenzhen (CN)

(73) Assignee: SHENZHEN SHOKZ CO., LTD., Shenzhen (CN)

(21) Appl. No.: 19/645,279

(22) Filed: Apr. 12, 2026

Related U.S. Application Data
(63) Continuation of application No. PCT/CN2024/096876, filed on May 31, 2024.

(51) Int. Cl. H04R 1/02; H04R 1/10

(52) U.S. Cl. CPC H04R 1/023; H04R 1/1008; H04R 1/1075; H04R 2460/11

(57) ABSTRACT

The present disclosure relates to an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber.

### CROSS-REFERENCE TO RELATED APPLICATIONS

This application is a continuation of International Application No. PCT/CN2024/096876 filed on May 31, 2024, the entire contents of which are incorporated herein by reference.

### TECHNICAL FIELD

The present disclosure relates to the field of electronic devices, and in particular, to an acoustic output device.

### BACKGROUND

The earphones are designed for users to wear and listen to sound. As a result, users can listen to sound during activities such as running or in non-sporting situations. However, in certain scenarios, users may find that the sound performance of the earphones is poorer during physical activities compared with that in non-sporting situations.

### SUMMARY

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh and a second mesh. The first mesh and the second mesh are both connected to the housing and configured to cover the first pressure relief hole. Along a propagation direction of an air-conduction sound generated by the air-conduction vibrator in the first pressure relief hole, the second mesh and the first mesh are arranged in sequence. The first mesh is closer to an outer side of the housing compared with the second mesh. A minimum spacing between the first mesh and the second mesh is not less than 0.2 mm.

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh, and the first mesh is connected to the housing and configured to cover the first pressure relief hole. The first mesh is provided with a plurality of mesh holes penetrating through the first mesh. Each of at least a portion of the plurality of mesh holes forms a contour line on an outer surface of the first mesh. The contour line has a minimum circumscribed sphere, and the minimum circumscribed sphere has a sphere center. On at least a portion of a section of the contour line, a distance between a point on the contour line and the sphere center changes along a circumferential direction of the contour line.

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh. The first mesh is connected to an outer side of the housing and configured to cover the first pressure relief hole. The first mesh is provided with at least one water-blocking groove penetrating through the first mesh, and the water-blocking groove has a strip shape.

### BRIEF DESCRIPTION OF THE DRAWINGS

To illustrate the technical solutions in the embodiments of the present disclosure more clearly, the following briefly introduces the accompanying drawings required for describing the embodiments. Obviously, the accompanying drawings in the following description show merely some embodiments of the present disclosure. A person of ordinary skill in the art may derive other drawings from these accompanying drawings without creative efforts.

FIG. 1 is a schematic diagram illustrating an exemplary structure of an acoustic output device according to some embodiments of the present disclosure;

FIG. 2 is a schematic diagram illustrating a front profile of an ear of a user according to some embodiments of the present disclosure;

FIG. 3 is a schematic diagram illustrating an exemplary structure of a core assembly in FIG. 1 according to some embodiments of the present disclosure;

FIG. 4 is a schematic diagram illustrating an exploded view of the core assembly in FIG. 3 according to some embodiments of the present disclosure;

FIG. 5 is a schematic assembly diagram of a portion of the core assembly in FIG. 3 according to embodiments of the present disclosure;

FIG. 6 is a schematic diagram illustrating an exemplary structure of the core assembly in FIG. 5 according to some other embodiments of the present disclosure;

FIG. 7 is a schematic diagram illustrating an exemplary structure of a first mesh in FIG. 6 according to embodiments of the present disclosure;

FIG. 8 is a schematic diagram illustrating a contour line formed by a mesh hole on an outer surface of the first mesh in FIG. 7 according to embodiments of the present disclosure;

FIG. 9 is a schematic diagram illustrating the contour line in FIG. 8 having 3 sides according to some embodiments of the present disclosure;

FIG. 10 is a schematic diagram illustrating the contour line in FIG. 8 having 4 sides according to some embodiments of the present disclosure;

FIG. 11 is a schematic diagram illustrating the contour line in FIG. 8 having 5 sides according to some embodiments of the present disclosure;

FIG. 12 is a schematic diagram illustrating an orthographic projection of the first mesh in FIG. 7 on a reference plane defined by a first direction X and a second direction Y according to some embodiments of the present disclosure;

FIG. 13 is a schematic diagram illustrating the core assembly in FIG. 5 according to some other embodiments of the present disclosure;

FIG. 14 is a schematic diagram illustrating the first mesh in FIG. 13 according to some embodiments of the present disclosure;

FIG. 15 is a schematic diagram illustrating an orthographic projection of the first mesh in FIG. 14 on the reference plane defined by the first direction X and the second direction Y according to some embodiments of the present disclosure;

FIG. 16 is a schematic diagram illustrating the orthographic projection of the first mesh in FIG. 14 on the reference plane defined by the first direction X and the second direction Y according to some other embodiments of the present disclosure;

FIG. 17 is a schematic diagram illustrating the orthographic projection of the first mesh in FIG. 14 on the reference plane defined by the first direction X and the second direction Y according to some other embodiments of the present disclosure;

FIG. 18 is a schematic diagram illustrating the orthographic projection of the first mesh in FIG. 14 on the reference plane defined by the first direction X and the second direction Y according to some other embodiments of the present disclosure;

FIG. 19 is a schematic diagram illustrating an exemplary structure of a portion of a mesh assembly in FIG. 5 according to some other embodiments of the present disclosure;

FIG. 20 is a schematic diagram illustrating an exemplary structure of a portion of the mesh assembly in FIG. 19 from another perspective;

FIG. 21 is a schematic diagram illustrating an exemplary structure of a portion of a housing in FIG. 4 according to some embodiments of the present disclosure; and

FIG. 22 is a schematic diagram illustrating cooperation between a second housing and a mesh assembly in FIG. 4 according to some embodiments of the present disclosure.

### DETAILED DESCRIPTION

The present disclosure is described in further detail below with reference to the accompanying drawings and embodiments. It is specifically noted that the following embodiments are merely for illustrating the present disclosure and do not limit the scope of the present disclosure. Similarly, the following embodiments are only part of the embodiments of the present disclosure and not all embodiments. All other embodiments obtained by a person of ordinary skill in the art without creative efforts fall within the scope of protection of the present disclosure.

The mention of “embodiment” in the present disclosure means that a specific feature, structure, or characteristic described in connection with the embodiment may be included in at least one embodiment of the present disclosure. A person skilled in the art explicitly and implicitly understands that the embodiments described in the present disclosure may be combined with other embodiments.

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh and a second mesh. The first mesh and the second mesh are both connected to the housing and configured to cover the first pressure relief hole. Along a propagation direction of an air-conduction sound generated by the air-conduction vibrator in the first pressure relief hole, the second mesh and the first mesh are arranged in sequence. The first mesh is closer to an outer side of the housing compared with the second mesh. A minimum spacing between the first mesh and the second mesh is not less than 0.2 mm.

In some embodiments, at least a portion of the first mesh is exposed to the outer side of the housing. The second mesh is connected to an interior of the first pressure relief hole or an interior of the first acoustic chamber.

In some embodiments, the acoustic output device further includes a mesh bracket. The mesh bracket is disposed in the housing and is connected to the housing. The second mesh is disposed on the mesh bracket.

In some embodiments, the second mesh is disposed on a side of the mesh bracket away from the first mesh.

In some embodiments, the housing includes a first housing and a second housing. The first housing and the second housing are engaged with each other. An inner side of the first housing and/or the second housing is provided with a limiting slot. Along an engagement direction of the first housing and the second housing, the mesh bracket is inserted into the limiting slot.

In some embodiments, there are two limiting slots. The two limiting slots are disposed on the first housing and the second housing, respectively. Along the engagement direction, one end of the mesh bracket is inserted into the limiting slot on the first housing, and the other end of the mesh bracket is inserted into the limiting slot on the second housing.

In some embodiments, the first pressure relief hole includes two sub-pressure relief holes. One of the two sub-pressure relief holes is disposed in the first housing, and the other of the two sub-pressure relief holes is disposed in the second housing. The second mesh is configured to cover the two sub-pressure relief holes simultaneously.

In some embodiments, the mesh bracket is provided with two sound-guiding windows. The two sound-guiding windows are spaced apart along the engagement direction and are arranged corresponding to the two sub-pressure relief holes, respectively. The second mesh is configured to cover the two sound-guiding windows simultaneously.

In some embodiments, the first housing and/or the second housing includes a housing wall and a stopping portion. The stopping portion is disposed on an inner side of the housing wall and is spaced apart from an inner wall surface of the housing wall. The limiting slot is located between the housing wall and the stopping portion. When the mesh bracket is inserted into the limiting slot, the stopping portion is configured to connect the mesh bracket such that the mesh bracket abuts against the inner wall surface of the housing wall.

In some embodiments, the first mesh and the second mesh are stacked.

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh. The first mesh is connected to the housing and configured to cover the first pressure relief hole. The first mesh is provided with a plurality of mesh holes penetrating through the first mesh. Each of at least a portion of the plurality of mesh holes forms a contour line on an outer surface of the first mesh. The contour line has a minimum circumscribed sphere, and the minimum circumscribed sphere has a sphere center. On at least a portion of a section of the contour line, a distance between a point on the contour line and the sphere center changes along a circumferential direction of the contour line.

In some embodiments, in the same contour line, each side is in the same plane.

In some embodiments, the contour line is a closed contour line.

In some embodiments, the closed contour line is a polygon.

In some embodiments, a count of sides of the closed contour line is not greater than 6.

In some embodiments, in the same contour line, among three sides connected in sequence, only a middle side among the three sides is a straight side or a curved side.

In some embodiments, a diameter of the minimum circumscribed sphere is not less than 0.4 mm.

In some embodiments, the plurality of mesh holes include a plurality of first mesh holes and a plurality of second mesh holes. Each of at least a portion of the plurality of first mesh holes forms a contour line on the outer surface of the first mesh, and/or, each of at least a portion of the plurality of second mesh holes forms a contour line on the outer surface of the first mesh. A diameter of the minimum circumscribed sphere corresponding to the first mesh hole is smaller than a diameter of the minimum circumscribed sphere corresponding to the second mesh hole.

In some embodiments, the plurality of first mesh holes are arranged around a periphery of the plurality of second mesh holes.

In some embodiments, on the outer surface of the first mesh, along a direction from an edge toward a center, a diameter of the minimum circumscribed sphere corresponding to a mesh hole closer to the center among two adjacent mesh holes is larger.

The present disclosure provides an acoustic output device. The acoustic output device comprises a housing and an air-conduction vibrator. The air-conduction vibrator is disposed in the housing. The housing includes a first acoustic chamber and a second acoustic chamber. The first acoustic chamber and the second acoustic chamber are located on two sides of a diaphragm of the air-conduction vibrator, respectively. The housing is provided with a sound outlet hole and a first pressure relief hole. The sound outlet hole is in communication with the first acoustic chamber, and the first pressure relief hole is in communication with the second acoustic chamber. The acoustic output device further comprises a first mesh. The first mesh is connected to an outer side of the housing and configured to cover the first pressure relief hole. The first mesh is provided with at least one water-blocking groove penetrating through the first mesh, and the water-blocking groove has a strip shape.

In some embodiments, a width of the water-blocking groove is not less than 0.4 mm, and/or a minimum distance between the water-blocking groove and an edge of the first mesh is not less than 0.8 mm.

In some embodiments, the housing has a first direction, a second direction, and a third direction orthogonal to each other. The housing includes a first housing wall and a second housing wall spaced apart along the first direction. The housing further includes a third housing wall. The third housing wall connects the first housing wall and the second housing wall. The first pressure relief hole is disposed in the third housing wall. The first mesh is connected to the third housing wall. In a wearing state, the first housing wall faces a head of a user. The second housing wall is disposed on a side of the first housing wall away from the head of the user. The third housing wall is located on a side of the housing away from a top of the head of the user along the third direction.

In some embodiments, on a reference plane parallel to the first direction and the second direction, a longitudinal direction of the water-blocking groove has an orthographic projection. The orthographic projection includes a first extension component along the first direction. The orthographic projection further includes a second extension component along the second direction.

In some embodiments, the second housing wall is provided with a second pressure relief hole. The second pressure relief hole is in communication with the second acoustic chamber.

In some embodiments, there are a plurality of water-blocking grooves. The plurality of water-blocking grooves are arranged spaced apart from each other.

In some embodiments, a spacing between two adjacent water-blocking grooves is not less than 0.4 mm.

In some embodiments, the first mesh further includes a plurality of mesh holes. The plurality of mesh holes are in communication with an inner surface of the first mesh and the outer surface of the first mesh.

In some embodiments, the mesh holes are arranged in a polygonal arrangement.

In some embodiments, the water-blocking groove is arranged in a bent arrangement.

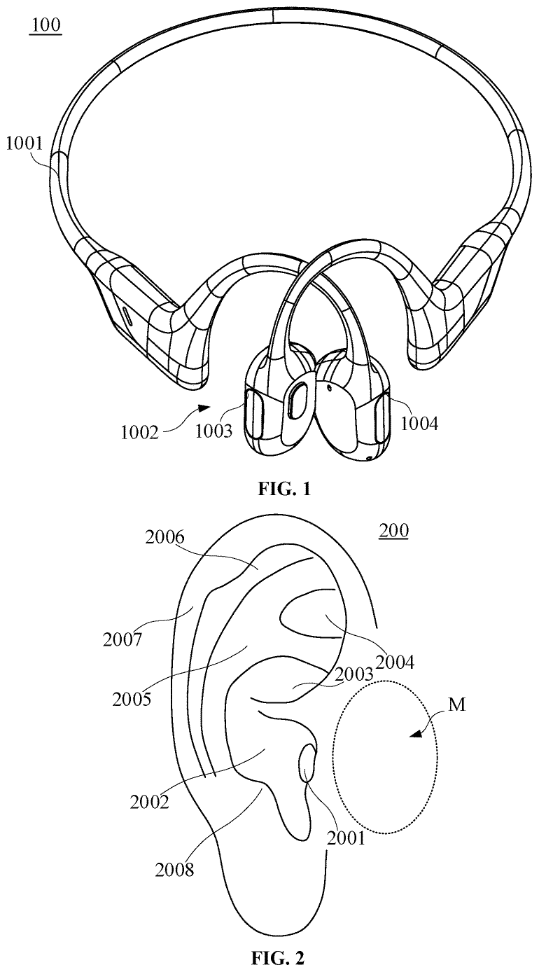

Referring to FIG. 1, FIG. 1 is a schematic diagram illustrating an exemplary structure of an acoustic output device according to some embodiments of the present disclosure. An acoustic output device 100 may serve as a sound source to output sound, for example, an air-conduction sound, a bone-conduction sound. The acoustic output device 100 may be worn on a head of a user and may be at least partially adjacent to ears of the user, such that sound may be transmitted to the ears of the user to enable the user to listen to the sound. In some embodiments, the acoustic output device 100 may be referred to as an “earphone.” In some embodiments, the acoustic output device 100 may also integrate other functions such as sound pickup, image display, etc., which are not described in detail. In some embodiments, the acoustic output device 100 may push an air load to generate an air-conduction sound, and may also push a physical load (e.g., the acoustic output device 100, user tissue, bone, etc.) to generate a bone-conduction sound.

The acoustic output device 100 may include a wearing member 1001 and a core assembly 1002 connected to the wearing member 1001. The wearing member 1001 cooperates with the core assembly 1002 to enable the core assembly 1002 to be worn on the head of the user.

The wearing member 1001 may be looped around or hung on the head of the user to be worn on the head of the user, or may be hung on the ears of the user at the same time. The wearing member 1001 may also be hung only on the ears, and thus the wearing member 1001 may also be referred to as an “ear hook.” A main function of the wearing member 1001 is to cooperate with the core assembly 1002, and therefore, the present disclosure may not limit a specific form of the wearing member 1001, as long as the wearing member 1001 can cooperate with the core assembly 1002 to enable the core assembly 1002 to be worn on the head of the user.

The core assembly 1002 refers to a structure for implementing main functions of the acoustic output device 100. For example, the core assembly 1002 may push an air load to generate an air-conduction sound. For example, the core assembly 1002 may push a physical load (e.g., the core assembly 1002, user tissue, bone, etc.) to generate a bone-conduction sound. Merely by way of example, the core assembly 1002 may implement other functions such as sound pickup and image display, which are not described in detail.

In some embodiments, when the core assembly 1002 pushes an air load to generate an air-conduction sound, the core assembly 1002 may not contact the user, or the core assembly 1002 may contact the user. In some embodiments, when the core assembly 1002 pushes a physical load to generate a bone-conduction sound, the core assembly 1002 may contact the user.

The core assembly 1002 may be worn on the head of the user through the wearing member 1001. Alternatively, the wearing member 1001 may be replaced with other structures, so that the core assembly 1002 is worn on the head of the user through other structures and/or other wearing manners, which is not described in detail.

Referring to FIG. 2, FIG. 2 is a schematic diagram illustrating a front profile of an ear of a user according to some embodiments of the present disclosure. An ear 200 may include physiological parts, such as an external auditory canal 2001, a concha cavity 2002, a concha cymba 2003, a triangular fossa 2004, an antihelix 2005, a scapha 2006, a helix 2007, and a tragus 2008. The external auditory canal 2001 has a certain depth and may extend to the tympanic membrane. However, for ease of description, the external auditory canal 2001 refers to an ear hole of the ear 200 unless otherwise specified in the present disclosure. In addition, physiological parts, such as the concha cavity 2002, the concha cymba 2003, and the triangular fossa 2004 may also have a certain volume and depth. The concha cavity 2002 may be directly in communication with the external auditory canal 2001, that is, it can be regarded as the ear hole being located at the bottom of the concha cavity 2002. In FIG. 2, a head of the user includes a facial region M adjacent to the ear 200. In some embodiments, the facial region M may be located on a front side of the ear 200. Alternatively, the facial region M may be divided and adjusted on the user's face according to the requirements of a person skilled in the art.

It should be noted that, in fields such as medicine and anatomy, three basic planes (i.e., a sagittal plane, a coronal plane, and a horizontal plane) of the human body and three basic axes (i.e., a sagittal axis, a coronal axis, and a vertical axis) of the human body may be defined. The sagittal plane refers to a plane perpendicular to the ground along an anterior-posterior direction of the body, and the sagittal plane divides the human body into a left part and a right part. The coronal plane refers to a plane perpendicular to the ground along a left-right direction of the body, and the coronal plane divides the human body into a front part and a rear part. The horizontal plane refers to a plane parallel to the ground along a superior-inferior direction of the body, and the horizontal plane divides the human body into an upper part and a lower part. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Further, the term “front side of the ear (also referred to as ear front side)” described in the present disclosure is a concept relative to a “rear side of the ear (also referred to as ear rear side)”. The front side of the ear refers to a side of the ear facing the face. The rear side of the ear refers to a side of the ear away from the face. When observing the ear 200 of the human body along the direction of the coronal axis, the ear 200 may be as shown in FIG. 2.

Referring to FIG. 1 and FIG. 2 together, when the acoustic output device 100 is worn on the head of the user, the acoustic output device 100 may be in a wearing state, and the core assembly 1002 may be disposed adjacent to the ear 200. Alternatively, the core assembly 1002 may contact the head of the user, the core assembly 1002 may contact the ear 200, or the core assembly 1002 may contact the face of the user.

In some embodiments, when the acoustic output device 100 is in the wearing state, the core assembly 1002 may be located in the facial region M adjacent to the ear 200 to be closer to the ear 200. In some embodiments, the core assembly 1002 may contact the facial skin in the facial region M to achieve stable wearing. In some embodiments, the contact between the core assembly 1002 and the facial skin in the facial region M may push a physical load (e.g., the core assembly 1002, user tissue, bone, etc.) to generate a bone-conduction sound.

Referring to FIG. 1, there may be two core assemblies 1002, for example, a first core assembly 1003 and a second core assembly 1004. The first core assembly 1003 may be worn on the ear 200 corresponding to a left side of the user. The second core assembly 1004 may be worn on the ear 200 corresponding to a right side of the user. In some embodiments, there may be one core assembly 1002. For example, one of the first core assembly 1003 and the second core assembly 1004 may be omitted.

In some embodiments, the first core assembly 1003 may be worn on the ear 200 corresponding to the left side of the user and may be located in the facial region M adjacent to the ear 200 on the left side of the user. The second core assembly 1004 may be worn on the ear 200 corresponding to the right side of the user and may be located in the facial region M adjacent to the ear 200 on the right side of the user.

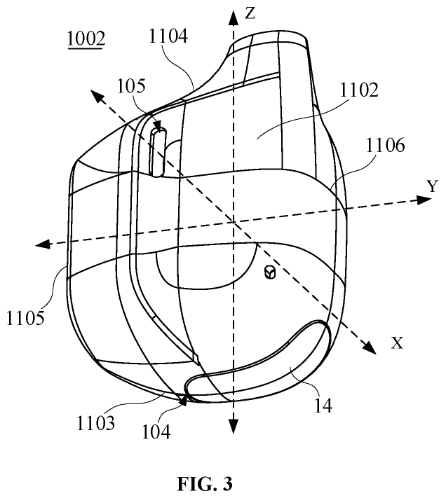

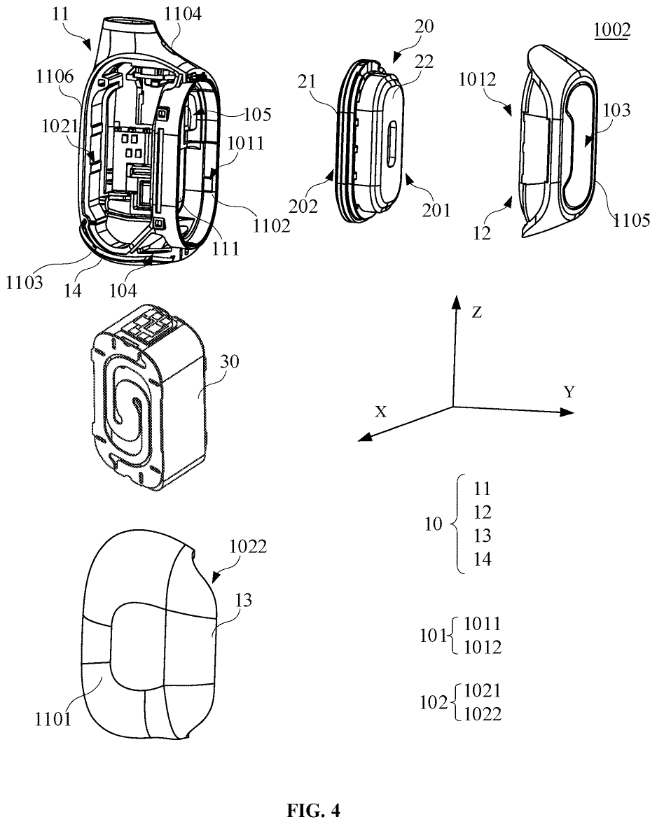

Referring to FIG. 3 and FIG. 4 together, FIG. 3 is a schematic diagram illustrating an exemplary structure of the core assembly 1002 in FIG. 1 according to some embodiments of the present disclosure, FIG. 4 is a schematic diagram illustrating an exploded view of the core assembly 1002 in FIG. 3 according to some embodiments of the present disclosure. The core assembly 1002 may include a housing 10 and an air-conduction vibrator 20 carried by the housing 10. The housing 10 may be configured to carry and mount the air-conduction vibrator 20. The air-conduction vibrator 20 may generate an air-conduction sound for transmission to the ear 200 of the user.

In some embodiments, the air-conduction vibrator 20 may include a diaphragm 21. When the diaphragm 21 vibrates, the diaphragm 21 may cause air vibration. According to the principle of air vibration, the diaphragm 21 may push an air load to generate a sound, and the diaphragm 21 may transmit the sound to the ear 200 of the user.

In some embodiments, in the housing 10, the housing 10 includes a first acoustic chamber 201 and a second acoustic chamber 202. The first acoustic chamber 201 and the second acoustic chamber 202 are located on two sides of the diaphragm 21 of the air-conduction vibrator 20, respectively.

In some embodiments, the first acoustic chamber 201 may be referred to as a “rear chamber” and the second acoustic chamber 202 may be referred to as a “front chamber.” In some embodiments, the distinction between the “front chamber” and the “rear chamber” is as follows: the “front chamber” is located on a side of the diaphragm 21 away from a magnetic circuit system 22, while the “rear chamber” is located on a side of the diaphragm 21 facing the magnetic circuit system 22. Alternatively, the distinction between the “front chamber” and the “rear chamber” may be based on techniques in the art.

In some embodiments, the air-conduction vibrator 20 may cooperate with the housing 10 to form the first acoustic chamber 201 and the second acoustic chamber 202 located on two sides of the diaphragm 21 of the air-conduction vibrator 20, respectively.

In some embodiments, the first acoustic chamber 201 and the second acoustic chamber 202 may be in communication with each other, which is beneficial to reducing the resistance of the diaphragm 21 of the air-conduction vibrator 20 during vibration. Alternatively, in some embodiments, the first acoustic chamber 201 and the second acoustic chamber 202 may not be in communication with each other. The two acoustic chambers are isolated from each other, which is beneficial to reducing interference between sounds. Specifically, the first acoustic chamber 201 and the second acoustic chamber 202 may be in communication with each other or may not be in communication with each other according to the requirements of a person skilled in the art.

In some embodiments, the magnetic circuit system 22 is configured to drive the diaphragm 21 to vibrate, that is, the magnetic circuit system 22 may also be a part of the air-conduction vibrator 20. Specifically, a process in which the diaphragm 21 vibrates or the magnetic circuit system 22 drives the diaphragm 21 to vibrate may be implemented based on conventional techniques in the art, which are not described in detail.

In some embodiments, the housing 10 is provided with a sound outlet hole 103 in communication with the first acoustic chamber 201. The sound outlet hole 103 is configured to transmit the air-conduction sound generated by the air-conduction vibrator 20 from the first acoustic chamber 201 to the outside of the housing 10.

In some embodiments, the housing 10 is provided with a first pressure relief hole 104 in communication with the second acoustic chamber 202. The first pressure relief hole 104 may allow the second acoustic chamber 202 to be in communication with the external environment (outside the housing 10). That is, air may flow between the second acoustic chamber 202 and the external environment, which is beneficial to reducing the resistance of the diaphragm 21 of the air-conduction vibrator 20 during vibration. In some embodiments, the first pressure relief hole 104 may cooperate with the sound outlet hole 103 to reduce far-field sound leakage of the acoustic output device 100.

In some embodiments, the housing 10 may include a mesh assembly 14 disposed at the first pressure relief hole 104. In some embodiments, the mesh assembly 14 may adjust the sound emitted by the air-conduction vibrator 20 to improve the acoustic performance of the acoustic output device 100. In some embodiments, the mesh assembly 14 may have a dustproof effect.

In some scenarios, the user may wear the acoustic output device 100 during exercise such as running, or during non-exercise. Research has found that the acoustic output device 100 may occasionally have poorer sound performance during exercise than during non-exercise. Further research shows that the user may produce a large amount of sweat during exercise. The sweat may accumulate at the first pressure relief hole 104, for example, at the mesh assembly 14, which reduces an effective flow-through area of the first pressure relief hole 104. Consequently, the resistance of the diaphragm 21 of the air-conduction vibrator 20 during vibration increases, resulting in poorer sound performance. Accordingly, the far-field sound leakage of the acoustic output device 100 may also increase.

In some embodiments, the mesh holes of the mesh assembly 14 may be improved. Specifically, a phenomenon of water accumulation at the mesh assembly 14 may be improved by adjusting the shapes or sizes of the mesh holes. The improvement may reduce water attached to the mesh assembly 14 and may reduce a blockage degree of first pressure relief hole 104. In some scenarios, the degree to which sound performance deteriorates due to the first pressure relief hole 104 being blocked by user sweat may be reduced, at least during user movement.

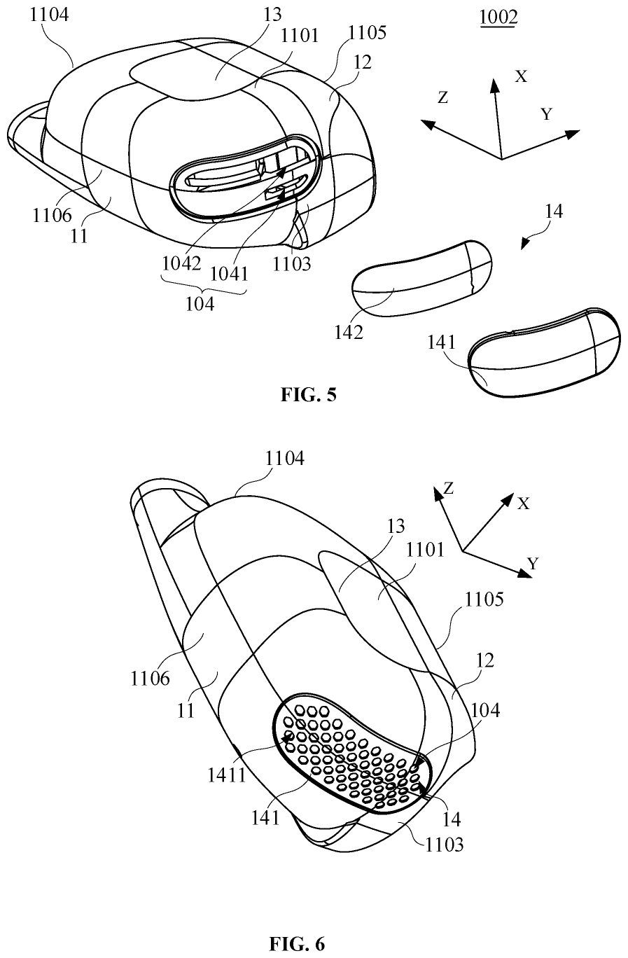

Referring to FIG. 5, FIG. 5 is a schematic assembly diagram of a portion of the core assembly 1002 in FIG. 3 according to embodiments of the present disclosure. The mesh assembly 14 may include a first mesh 141 configured to cover the first pressure relief hole 104. The first mesh 141 may provide support, protection, and covering functions. The first mesh 141 may reduce the probability of foreign objects entering the first pressure relief hole 104.

The first mesh 141 may be embedded at the first pressure relief hole 104. Alternatively, the first mesh 141 may be fixed at the first pressure relief hole 104 by means of adhesion, snap-fit connection, etc., to cover the first pressure relief hole 104. In some embodiments, at least a portion of the first mesh 141 may be exposed to an outer side of the housing 10.

The first mesh 141 may be a mesh structure made of metal or other materials.

Referring to FIG. 5, the mesh assembly 14 may further include a second mesh 142 configured to cover the first pressure relief hole 104. The second mesh 142 may be closer to the first pressure relief hole 104 compared with the first mesh 141. That is, the second mesh 142 and the first mesh 141 cooperate with each other and are configured to cover the first pressure relief hole 104.

In some embodiments, the first mesh 141 may cover the first pressure relief hole 104 on the outer side of the housing 10. The second mesh 142 may cover the first pressure relief hole 104 on an inner side of the first mesh 141.

In some embodiments, the second mesh 142 may be disposed with support from the first mesh 141. In some embodiments, the second mesh 142 may be arranged spaced apart from the first mesh 141, which may reduce the possibility of water passing through the first mesh 141 to contact the second mesh 142, and in some scenarios, may also reduce the possibility of water attaching between the first mesh 141 and the second mesh 142.

In some embodiments, the second mesh 142 may be an acoustic damping mesh. In some embodiments, the second mesh 142 may be a gauze mesh or other mesh materials that serve to attenuate sound.

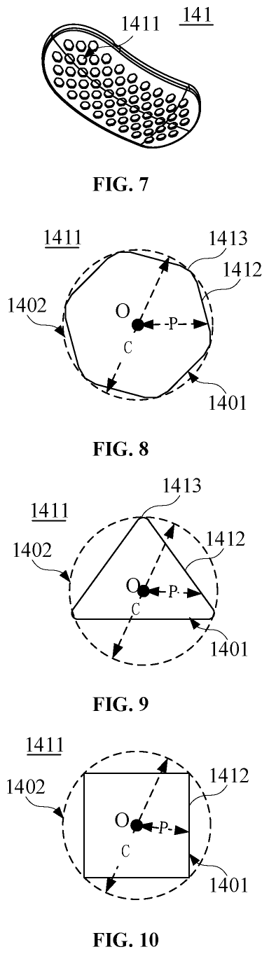

Referring to FIG. 6 and FIG. 7, FIG. 6 is a schematic diagram illustrating an exemplary structure of the core assembly 1002 in FIG. 5 according to some other embodiments of the present disclosure, FIG. 7 is a schematic diagram illustrating an exemplary structure of the first mesh 141 in FIG. 6 according to some embodiments of the present disclosure. The first mesh 141 is provided with a plurality of mesh holes 1411 penetrating through the first mesh 141. The mesh holes 1411 may transmit an air-conduction sound. The air-conduction sound generated by the air-conduction vibrator 20 may be transmitted from the second acoustic chamber 202 to the first pressure relief hole 104, and may be transmitted from the first pressure relief hole 104 to the mesh holes 1411, and then may be transmitted from the mesh holes 1411 to the outside of the housing 10.

In some embodiments, the plurality of mesh holes 1411 are distributed on the first mesh 141 at intervals. The distribution may increase a total open area of the first mesh 141 without increasing an area of a single mesh hole 1411. The increased total open area may facilitate transmission of sound waves from the second acoustic chamber 202 to the external environment. It can be understood that increasing the area of a single mesh hole 1411 is not conducive to the protective effect of the first mesh 141.

FIG. 8 is a schematic diagram illustrating a contour line formed by the mesh hole 1411 on an outer surface of the first mesh 141 in FIG. 7 according to some embodiments of the present disclosure. At least one mesh hole 1411 forms a contour line 1401 on the outer surface of the first mesh 141. One contour line 1401 corresponds to one mesh hole 1411. At least one contour line 1401 may be a closed contour line. In some cases, at least one contour line 1401 may be a non-closed contour line. The contour line 1401 shown in FIG. 8 is a closed contour line and corresponds to one mesh hole 1411.

Merely by way of example, one mesh hole 1411 having a closed contour line is described in further detail below.

The contour line 1401 may have a minimum circumscribed sphere 1402. Correspondingly, the minimum circumscribed sphere 1402 may have a sphere center O. On at least a portion of a section of the contour line 1401, a distance P between a point on the contour line 1401 and the sphere center O changes along a circumferential direction of the contour line 1401. It can be understood that the contour line 1401 in FIG. 8 in a non-closed state may also form the minimum circumscribed sphere 1402, and on at least a portion of a section of the contour line 1401, the distance P between a point on the contour line 1401 and the sphere center O changes along the circumferential direction of the contour line 1401.

For the contour line 1401, based on a design of the outer surface of the first mesh 141, all sections of the contour line 1401 may lie in the same plane. Accordingly, the minimum circumscribed sphere 1402 may be replaced with a minimum circumscribed circle, and the sphere center O may be replaced with the center of the minimum circumscribed circle.

Alternatively, based on the design of the outer surface of the first mesh 141, all sections of the contour line 1401 may not lie in the same plane.

Research has found that water forms a curved surface due to surface tension. The curved surface largely adapts to a smooth boundary of a circle. Accordingly, a boundary of a circular mesh hole may be more suitable for water accumulation, causing the circular mesh hole to be blocked by a water film.

However, in the above embodiments, the distances P of the mesh hole 1411 are not completely equal, indicating that the mesh hole 1411 is a non-circular mesh hole. Accordingly, a tension balance when water attaches to the mesh hole 1411 may be more easily broken, which makes it more difficult for water to accumulate within the mesh hole 1411, thereby reducing the blockage degree of the first pressure relief hole 104. In some scenarios, a phenomenon of sweat accumulation at the mesh hole 1411 may be improved, at least during user movement, thereby reducing the degree to which sound performance deteriorates due to coverage of the first pressure relief hole 104 by user sweat.

In some embodiments, on the contour line 1401, the distance P between a point on the contour line 1401 and the sphere center O changes along the circumferential direction of the contour line 1401. The changing distance P may facilitate increasing difficulty of water accumulation within the mesh hole 1411 and may reduce the risk of water film blocking the mesh hole 1411.

In some embodiments, the contour line 1401 may be a polygon having a plurality of straight sides 1412, which reduces a smoothness of an inner wall of the mesh hole 1411 and increases a difficulty of a water film attaching to the inner wall of the mesh hole 1411, thereby reducing the risk of water film blocking the mesh hole 1411.

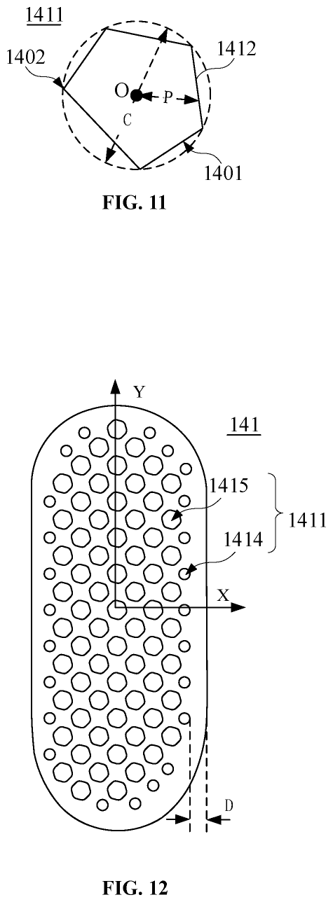

In some embodiments, a count of sides of the contour line 1401 may be any one of 3, 4, 5, or 6, which reduces the smoothness of the inner wall of the mesh hole 1411 and increases the difficulty of the water film attaching to the inner wall of the mesh hole 1411, thereby reducing the risk of water film blocking the mesh hole 1411. Referring to FIG. 9, FIG. 10, and FIG. 11, FIG. 9 is a schematic diagram illustrating the contour line 1401 in FIG. 8 having 3 sides according to some embodiments of the present disclosure, FIG. 10 is a schematic diagram illustrating the contour line 1401 in FIG. 8 having 4 sides according to some embodiments of the present disclosure, FIG. 11 is a schematic diagram illustrating the contour line 1401 in FIG. 8 having 5 sides according to some embodiments of the present disclosure.

Referring to FIG. 8 and FIG. 9A, vertices of the contour line 1401 may be rounded to form a curved side 1413. The curved side 1413 may facilitate processing of the mesh hole 1411 on the first mesh 141 by reducing processing difficulty. Additionally, the curved side 1413 may enlarge the mesh hole 1411 within a limited space and may ensure sound performance of the acoustic output device 100.

In some embodiments, the curved side 1413 may be an arc side.

In some embodiments, on the contour line 1401, among three sides connected in sequence, only a middle side among the three sides is the straight side 1412 or the curved side 1413.

In some embodiments, on the contour line 1401, one curved side 1413 connects two adjacent straight sides 1412.

In some embodiments, a diameter C of the minimum circumscribed sphere 1402 is not less than 0.4 mm. The diameter C may not only facilitate processing of the mesh hole 1411 but also may facilitate reducing the risk of water film blocking the mesh hole 1411.

Referring to FIG. 3 and FIG. 4, the housing 10 has a first direction X, a second direction Y, and a third direction Z orthogonal to each other. In the wearing state, the first direction X may be a coronal axis direction or a direction having an angle with the coronal axis. In the wearing state, the second direction Y may be a sagittal axis direction or a direction having an angle with the sagittal axis. In the wearing state, the third direction Z may be a vertical axis direction or a direction having an angle with the vertical axis.

In some embodiments, the housing 10 may include a first housing wall 1101 and a second housing wall 1102 spaced apart along the first direction X. In the wearing state, the first housing wall 1101 may face the head of the user, and the second housing wall 1102 may be disposed on a side of the first housing wall 1101 away from the head of the user.

In some embodiments, in the wearing state, the first housing wall 1101 may face the facial region M in front of the ear 200 of the user, and the second housing wall 1102 may be located on a side of the first housing wall 1101 away from the facial region M. In some embodiments, the first housing wall 1101 may contact the facial skin in the facial region M.

In some embodiments, in the wearing state, the sound outlet hole 103 may be disposed on a side of the housing 10 facing the ear 200. In some embodiments, in the wearing state, the sound outlet hole 103 may be disposed on a side of the housing 10 facing the ear 200 along the second direction Y.

In some embodiments, the housing 10 further includes a third housing wall 1103 connecting the first housing wall 1101 and the second housing wall 1102. In some embodiments, the first pressure relief hole 104 is disposed in the third housing wall 1103. In some embodiments, the first mesh 141 is fixed on the third housing wall 1103. In some embodiments, the first mesh 141 is connected to an outer side of the third housing wall 1103 or embedded in the third housing wall 1103. It should be understood that when a setting position of the first pressure relief hole 104 changes, the first mesh 141 may be connected to an outer side of other housing wall(s) of the housing 10.

In the wearing state, the third housing wall 1103 may be disposed on a side of the housing 10 away from a top of the head of the user along the third direction Z, thereby causing the first pressure relief hole 104 to be located at a relatively lower position on a vertical axis. When sweat flows on the surface of the housing 10, at least part of the sweat flows toward a lower position along the vertical axis and tends to accumulate at the first pressure relief hole 104. By providing non-circular mesh holes 1411 of the first mesh 141, the blockage degree of the first pressure relief hole 104 can be reduced.

In addition, the setting position of the first pressure relief hole 104 as described above is conducive to reducing the risk of sound waves transmitted through the first pressure relief hole 104 forming sound leakage and being heard by the user.

In some embodiments, the housing 10 is provided with a second pressure relief hole 105 in communication with the second acoustic chamber 202. When the first pressure relief hole 104 is affected by sweat, the second pressure relief hole 105 can assist the first pressure relief hole 104 in pressure relief. The second pressure relief hole 105 allows air to flow in and flow out of the second acoustic chamber 202, compensating for a deficiency after the first pressure relief hole 104 is affected by sweat. The second pressure relief hole 105 can also reduce the resistance of the diaphragm 21 of the air-conduction vibrator 20 during vibration, and can cooperate with the sound outlet hole 103 to reduce the far-field sound leakage of the acoustic output device 100.

It is understandable that, in the wearing state of the acoustic output device 100, the first pressure relief hole 104 may not only be blocked by sweat, but may also be blocked by dust, oil stains, water, obstacles, or the like. The provision of the second pressure relief hole 105 can improve deficiencies caused by blockage of the first pressure relief hole 104, and reduce the impact of the first pressure relief hole 104 being blocked on the sound performance of the acoustic output device 100.

In some embodiments, the second pressure relief hole 105 is disposed in the second housing wall 1102, thereby having a different position from the first pressure relief hole 104, which reduces the probability of the first pressure relief hole 104 and the second pressure relief hole 105 being blocked at the same time.

In the wearing state, the second housing wall 1102 is located on a side of the first housing wall 1101 away from the head of the user, and thus does not contact the facial skin of the head of the user, greatly reducing the possibility of sweat from the user's skin flowing toward the second pressure relief hole 105. It should be understood that the second pressure relief hole 105 may also be disposed in other housing wall(s) of the housing 10 as needed.

In some embodiments, an opening area of the second pressure relief hole 105 may be smaller than an opening area of the first pressure relief hole 104.

Referring to FIG. 12, FIG. 12 is a schematic diagram illustrating an orthographic projection of the first mesh 141 in FIG. 7 onto a reference plane defined by the first direction X and the second direction Y. A minimum distance D between the mesh holes 1411 and an edge of the first mesh 141 is not less than 0.8 mm, which simplifies a processing and manufacturing process of the first mesh 141, saves processing and manufacturing costs, and reduces an impact of the mesh holes 1411 on structural strength and stiffness of the first mesh 141, thereby lowering a risk of damage or deformation of the first mesh 141. The distance D refers to a minimum distance between edges of the mesh holes 1411 and the edge of the first mesh 141 on the outer surface of the first mesh 141.

In some embodiments, the reference plane may be parallel to the first direction X and the second direction Y, respectively.

The mesh holes 1411 may include a plurality of first mesh holes 1414 and a plurality of second mesh holes 1415. Through the cooperation of the first mesh holes 1414 and the second mesh holes 1415, different patterns can be formed to improve the appearance expression of the acoustic output device 100. It should be understood that settings of the first mesh holes 1414 and the second mesh holes 1415 may also be adjusted according to the needs of those skilled in the art.

In some embodiments, a diameter of a minimum circumscribed sphere of a contour line corresponding to the first mesh hole 1414 is smaller than a diameter of a minimum circumscribed sphere of a contour line corresponding to the second mesh hole 1415.

In some embodiments, the contour line corresponding to the first mesh hole 1414 is the contour line 1401 described in any of the foregoing embodiments. In some embodiments, the contour line corresponding to the second mesh hole 1415 is the contour line 1401 described in any of the foregoing embodiments.

In some embodiments, the plurality of first mesh holes 1414 are arranged around a periphery of the plurality of second mesh holes 1415. Corresponding to a smaller diameter of the first mesh hole 1414, a strength of a region of the first mesh 141 corresponding to the first mesh hole 1414 can be enhanced to serve a support and fixing function. Corresponding to a larger diameter of the second mesh hole 1415, a flexibility of a region of the first mesh 141 corresponding to the second mesh hole 1415 can be enhanced to serve a support and protection function. In FIG. 12, the first mesh holes 1414 are close to the edge of the first mesh 141, thereby allowing the stiffness of the first mesh 141 to be maintained within a reasonable range, facilitating better connection and fixation with the third housing wall 1103 at the mesh holes 1411, and further improving the support function of the first mesh 141. In FIG. 12, the second mesh holes 1415 are close to a middle portion of the first mesh 141, thereby providing a greater flexibility when the middle portion of the first mesh 141 is suspended, and improving the support and protection function.

In some embodiments, the mesh holes 1411 may not be limited to including the first mesh holes 1414 and the second mesh holes 1415, and may also include other mesh holes. Therefore, in some embodiments, diameters of minimum circumscribed spheres of contour lines corresponding to the mesh holes 1411 may be set to increase along a direction toward a center of the outer surface of the first mesh 141, to optimize the strength distribution of the first mesh 141. That is, on the outer surface of the first mesh 141, along a direction from the edge toward the center, among two adjacent mesh holes 1411, a diameter of a minimum circumscribed sphere of a contour line corresponding to one mesh hole 1411 closer to the center of the first mesh 141 is larger.

For example, in FIG. 12, along the first direction X, diameters of minimum circumscribed spheres of contour lines corresponding to the mesh holes 1411 are set to increase along the direction toward the center of the outer surface of the first mesh 141. For example, in FIG. 12, along the second direction Y, diameters of minimum circumscribed spheres of contour lines corresponding to the mesh holes 1411 are set to increase along the direction toward the center of the outer surface of the first mesh 141.

Research has found that the mesh assembly 14 can be improved, specifically by altering the structure of the mesh assembly 14 itself to generate capillary effects, thereby disrupting the tension balance of the water film covering the mesh assembly 14 based on capillary action, and reducing the blockage degree of the first pressure relief hole 104. In some scenarios, the degree of sound performance degradation caused by the blockage of the first pressure relief hole 104 by user sweat can be reduced, at least during user movement.

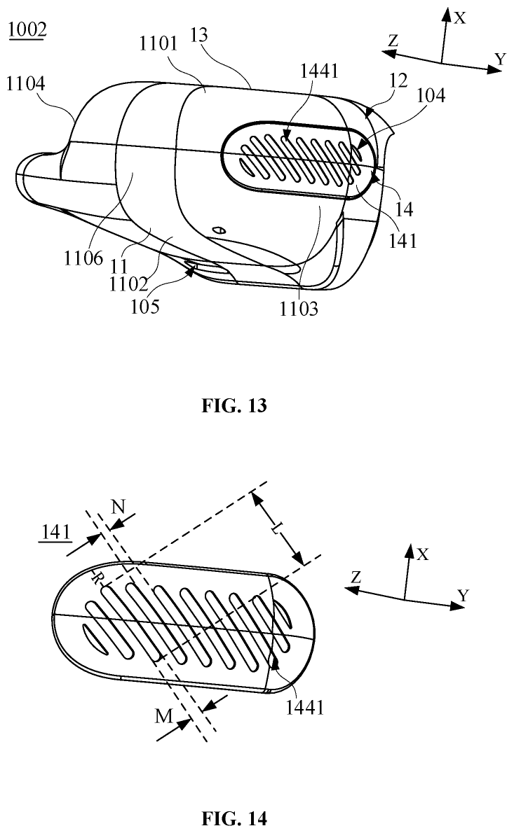

Referring to FIG. 13, FIG. 13 is a schematic diagram illustrating the core assembly 1002 in FIG. 5 according to some other embodiments of the present disclosure. At least one water-blocking groove 1441 having a strip shape is disposed on the first mesh 141, and the water-blocking groove 1441 may penetrate through the first mesh 141. The water-blocking groove 1441 can change the structure of the first mesh 141 itself that can generate a capillary phenomenon, so that a tension balance of a water film covering the first mesh 141 based on the capillary phenomenon is disrupted, thereby increasing the difficulty for water to accumulate at the water-blocking groove 1441, and reducing the blockage of the first pressure relief hole 104 by the water film. In some scenarios, the degree of sound performance degradation caused by the blockage of the first pressure relief hole 104 by user sweat can be reduced, at least during user movement.

It is understandable that when water is on the first mesh 141, the water-blocking groove 1441 having a strip shape reduces an area of the outer surface of the first mesh 141. As a result, when it becomes difficult for water to accumulate at the water-blocking groove 1441, a part of the water is more likely to accumulate on a solid structure of the outer surface of the first mesh 141. The reduction in the area of the outer surface of the first mesh 141 causes water to cluster on the first mesh 141 and then drip off, which is beneficial for reducing water accumulation at the first mesh 141 and lowering the risk of the first mesh 141 being blocked by a water film.

Referring to FIG. 14, FIG. 14 is a schematic diagram illustrating an exemplary structure of the first mesh 141 in FIG. 13 according to some embodiments of the present disclosure. A width M of the water-blocking groove 1441 is not less than 0.4 mm, which is not only beneficial for reducing the probability of the water-blocking groove 1441 being blocked by a water film, but also beneficial for facilitating processing and manufacturing, and saving processing and manufacturing costs of the first mesh 141.

In some embodiments, a length L of the water-blocking groove 1441 may be set to form a hole having a strip shape according to the needs of those skilled in the art.

In some embodiments, there may be a plurality of water-blocking grooves 1441.

In some embodiments, the water-blocking groove 1441 is a through groove penetrating through the first mesh 141, thereby serving a function of transmitting an air-conduction sound. This allows the air-conduction sound generated by the air-conduction vibrator 20 to be transmitted from the second acoustic chamber 202 to the first pressure relief hole 104, then from the first pressure relief hole 104 to the water-blocking groove 1441, and finally transmitted to the outside of the housing 10. In some embodiments, at least a portion of the plurality of water-blocking grooves 1441 are through grooves.

In the wearing state, the third housing wall 1103 may be disposed along the third direction Z on a side of the housing 10 away from the head of the user, thereby causing the first pressure relief hole 104 to be located at a relatively lower position on a vertical axis. When sweat flows on a surface of the housing 10, under the action of gravity, at least part of the sweat flows downward along the vertical axis and tends to accumulate at the first pressure relief hole 104. By providing the water-blocking groove 1441 having a strip shape on the first mesh 141, the blockage degree of the first pressure relief hole 104 may be reduced.

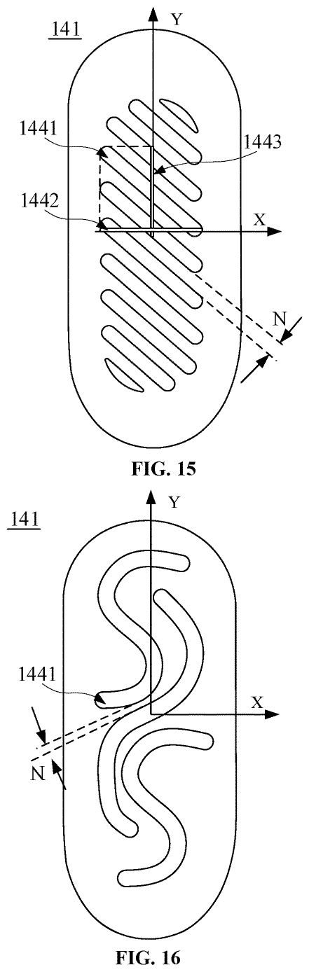

Referring to FIG. 15, FIG. 15 is a schematic diagram illustrating an orthographic projection of the first mesh 141 in FIG. 14 onto the reference plane defined by the first direction X and the second direction Y. An orthographic projection of a longitudinal direction of the water-blocking groove 1441 onto the reference plane includes extension components along the first direction X and the second direction Y, respectively. For example, the orthographic projection of the longitudinal direction of the water-blocking groove 1441 onto the reference plane includes a first extension component 1442 along the first direction X. For example, the orthographic projection of the longitudinal direction of the water-blocking groove 1441 onto the reference plane includes a second extension component 1443 along the second direction Y. The first extension component 1442 and the second extension component 1443 may cause the water-blocking groove 1441 to have an angle with the first direction X and the second direction Y, respectively.

In the wearing state, the third housing wall 1103 may be disposed along the third direction Z on a side of the housing 10 away from the head of the user, thereby causing the first pressure relief hole 104 to be located at a relatively lower position on a vertical axis. When sweat flows on a surface of the housing 10, at least part of the sweat flows downward along the vertical axis and accumulates at the first pressure relief hole 104. The angles between the water-blocking groove 1441 and the first direction X and the second direction Y, respectively, cause the water-blocking groove 1441 to have a guiding effect on the sweat. During the guiding process, a contact area between the sweat and the first mesh 141 is reduced, which facilitates the sweat to gather and drip, thereby reducing the impact of the sweat on the first pressure relief hole 104.

Referring to FIG. 14, a plurality of water-blocking grooves 1441 may be arranged spaced apart from each other. A spacing N between two adjacent water-blocking grooves 1441 is not less than 0.4 mm, so that as many water-blocking grooves 1441 as possible may be provided while ensuring that a stiffness of the first mesh 141 remains within a reasonable range. In some embodiments, the spacing N may be a minimum distance measured between two adjacent water-blocking grooves 1441 on the outer surface of the first mesh 141. In some embodiments, a minimum distance R between the water-blocking groove 1441 and the edge of the first mesh 141 is not less than 0.8 mm, which facilitates simplification of a processing and manufacturing process of the first mesh 141, saves processing and manufacturing costs, and also is conducive to reducing the impact of the water-blocking groove 1441 on a structural strength and the stiffness of the first mesh 141, thereby lowering the risk of damage or deformation of the first mesh 141. The distance R refers to a minimum distance on the outer surface of the first mesh 141 between an edge of the water-blocking groove 1441 and the edge of the first mesh 141.

Referring to FIG. 16, FIG. 16 is a schematic diagram illustrating an orthographic projection of the first mesh 141 in FIG. 14 onto the reference plane defined by the first direction X and the second direction Y. The water-blocking groove 1441 may be arranged in a bent arrangement. Such an arrangement facilitates increasing the length of the water-blocking groove 1441 without increasing the width of the water-blocking groove 1441, thereby increasing an open area of the water-blocking groove 1441. If the width of the water-blocking groove 1441 is too large, a protective effect of the water-blocking groove 1441 is not favorable. Increasing the length and the open area of the water-blocking groove 1441 is conducive to disrupting a tension balance of a water film attached to the water-blocking groove 1441, thereby reducing the risk of the water-blocking groove 1441 being blocked by the water film. It should be understood that the water-blocking groove 1441 in the above embodiments may also be arranged in a bent arrangement along the longitudinal direction of the water-blocking groove 1441.

In some embodiments, shapes of different water-blocking grooves 1441 may also be different.

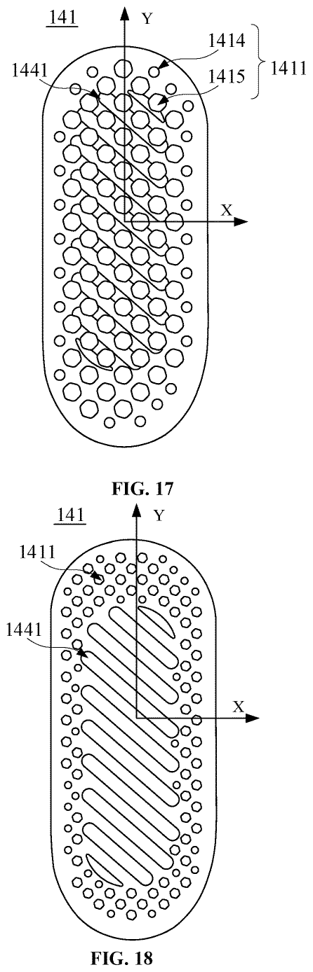

Referring to FIG. 17, FIG. 17 is a schematic diagram illustrating an orthographic projection of the first mesh 141 in FIG. 14 onto the reference plane defined by the first direction X and the second direction Y. There may be a plurality of mesh holes 1411. In some embodiments, a portion of the mesh holes 1411 may be in communication with at least one water-blocking groove 1441. In some embodiments, a plurality of mesh holes 1411 may be in communication with a same water-blocking groove 1441, and the mesh holes 1411 may be arranged spaced apart along the longitudinal direction of the water-blocking groove 1441.

Referring to FIG. 18, FIG. 18 is a schematic diagram illustrating an orthographic projection of the first mesh 141 in FIG. 14 onto the reference plane defined by the first direction X and the second direction Y. A plurality of mesh holes 1411 may be arranged around a periphery of a plurality of water-blocking grooves 1441.

In some embodiments, diameters of minimum circumscribed spheres 1402 of contour lines corresponding to at least a portion of the mesh holes 1411 on the outer surface of the first mesh 141 are less than or equal to a width M of the water-blocking groove 1441. Limiting size(s) of the mesh hole(s) 1411 can maintain a stiffness of the first mesh 141 within a reasonable range, thereby facilitating better connection and fixation with the third housing wall 1103 at the mesh holes 1411 and realizing a support function of the first mesh 141. In some embodiments, a diameter of a minimum circumscribed sphere of a contour line corresponding to the first mesh hole 1414 on the outer surface of the first mesh 141 is less than or equal to the width M of the water-blocking groove 1441. In some embodiments, a diameter of a minimum circumscribed sphere of a contour line corresponding to the second mesh hole 1415 on the outer surface of the first mesh 141 is less than or equal to the width M of the water-blocking groove 1441.

In some embodiments, a portion of the mesh holes 1411 may be arranged in a region where the plurality of water-blocking grooves 1441 are provided, resulting in a configuration as shown in FIG. 17. By providing the water-blocking groove 1441 on the outer surface of the first mesh 141, a portion of the mesh holes 1411 may be in communication with the water-blocking groove 1441. Therefore, forming the water-blocking groove 1441 on the first mesh 141 where a portion of the mesh holes 1411 are provided facilitates processing.

Research has found that the impact of sweat on the first pressure relief hole 104 may lie in a small spacing between layers of the mesh assembly 14, which makes it easier for sweat to permeate from the outside to the inside and adhere to the adjacent layers, leading to a more severe accumulation of water at the mesh assembly 14 and increasing the blockage degree of the first pressure relief hole 104.

In some embodiments, a layered structure of the mesh assembly 14 may be improved. Specifically, a problem of water accumulation at the mesh assembly 14 may be solved by adjusting a spacing between the layers of the mesh assembly 14, thereby reducing the blockage degree of the first pressure relief hole 104. In some scenarios, the degree of sound performance degradation caused by the blockage of the first pressure relief hole 104 by user sweat can be reduced, at least during user movement.

Referring to FIG. 5, a minimum spacing between the first mesh 141 and the second mesh 142 may be not less than 0.2 mm. By controlling the minimum spacing between the first mesh 141 and the second mesh 142, the probability of water accumulation between the first mesh 141 and the second mesh 142 may be reduced, thereby reducing the blockage degree of the first pressure relief hole 104. In some scenarios, the minimum spacing between the first mesh 141 and the second mesh 142 may reduce the degree of sound performance degradation caused by the blockage of the first pressure relief hole 104 by user sweat, at least during user movement.

In some embodiments, the second mesh 142 may be stacked with the first mesh 141. The minimum spacing between the first mesh 141 and the second mesh 142 may be a distance between the second mesh 142 and the first mesh 141 along a stacking direction.

In some embodiments, the air-conduction sound generated by the air-conduction vibrator 20 may propagate through the first pressure relief hole 104. Along a propagation direction, the second mesh 142 and the first mesh 141 may be arranged sequentially to cover the first pressure relief hole 104, respectively, achieving coordinated cooperation.

In some embodiments, the first mesh 141 is closer to the outer side of the housing 10 compared with the second mesh 142, thereby achieving the support and protection of the second mesh 142 through the first mesh 141.

In some embodiments, the second mesh 142 may cover the first pressure relief hole 104 on an inner side of the housing 10. In some embodiments, the second mesh 142 may cover the first pressure relief hole 104 in the first pressure relief hole 104. In some embodiments, the second mesh 142 may cover the first pressure relief hole 104 in the second acoustic chamber 202. In some embodiments, the second mesh 142 may be indirectly supported by the first mesh 141, and the minimum spacing between the first mesh 141 and the second mesh 142 along the stacking direction may be maintained, that is, the second mesh 142 may be disposed on the first mesh 141.

In some embodiments, the second mesh 142 may be directly fixed to the first mesh 141.

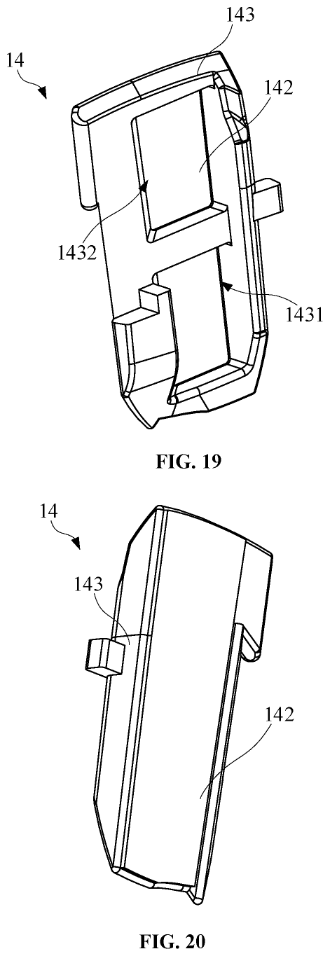

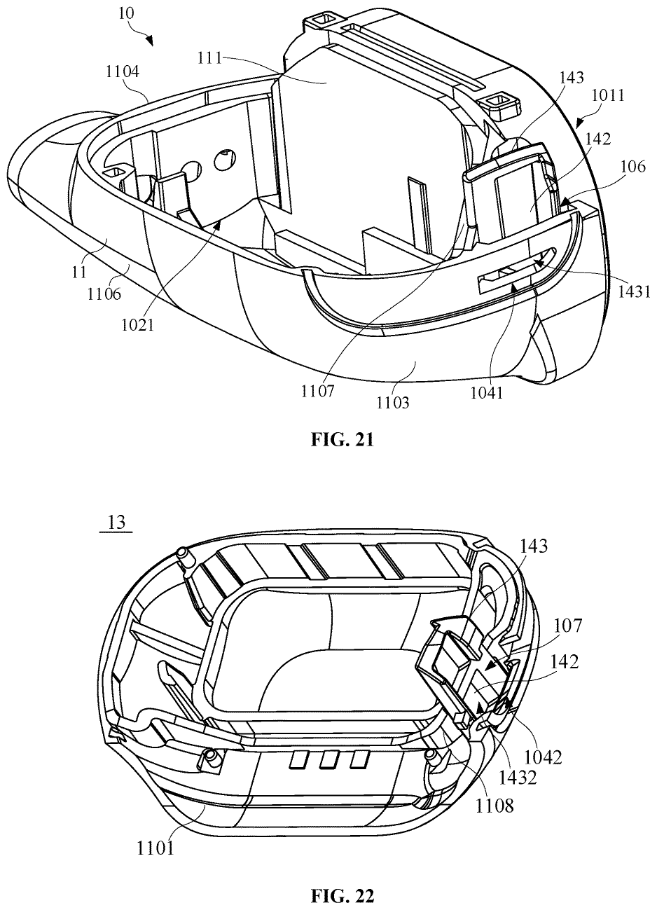

Referring to FIG. 19, FIG. 20, and FIG. 21, FIG. 19 is a schematic diagram illustrating an exemplary structure of a portion of the mesh assembly 14 in FIG. 5 according to some other embodiments of the present disclosure, FIG. 20 is a schematic diagram illustrating an exemplary structure of a portion of the mesh assembly 14 in FIG. 19 from another perspective, FIG. 21 is a schematic diagram illustrating an exemplary structure of a portion of the housing 10 in FIG. 4. The mesh assembly 14 may further include a mesh bracket 143. The mesh bracket 143 may be configured to support and fix the second mesh 142. The mesh bracket 143 may facilitate support of the second mesh 142, improve stability of connection of the second mesh 142 to the housing 10, ensure that a distance between the second mesh 142 and the first mesh 141 is not less than the minimum spacing, facilitate overall assembly of the housing 10, and simplify an assembly process of the second mesh 142 on the housing 10.

In some embodiments, the mesh bracket 143 may be fixed on the first mesh 141 to achieve a spaced arrangement of the first mesh 141 and the second mesh 142. In this case, at least a portion of the mesh bracket 143 may be disposed in the first pressure relief hole 104 (as shown in FIG. 21).

In some embodiments, the mesh bracket 143 may be disposed on the inner side of the housing 10 (as shown in FIG. 21) and may be assembled and connected to a housing wall of the housing 10 to achieve a spaced arrangement of the first mesh 141 and the second mesh 142. A portion of the housing wall is located between the first mesh 141 and the second mesh 142, which is beneficial for increasing the minimum spacing between the first mesh 141 and the second mesh 142 and reducing the risk of sweat adhering to the first mesh 141 and the second mesh 142 simultaneously. In addition, in some scenarios, the minimum spacing between the first mesh 141 and the second mesh 142 may be adjusted by adjusting a thickness of the housing wall of the housing 10. In some scenarios, the minimum spacing between the first mesh 141 and the second mesh 142 may also be adjusted by adjusting a thickness or a shape of the mesh bracket 143.

In some embodiments, the second mesh 142 may be disposed on a side of the mesh bracket 143 away from the first mesh 141, which is beneficial for increasing the minimum spacing between the first mesh 141 and the second mesh 142 and reducing the risk of sweat adhering to the first mesh 141 and the second mesh 142 simultaneously. It should be understood that the second mesh 142 may also be disposed on a side of the mesh bracket 143 close to the first mesh 141.

It is understood that a setting position of the second mesh 142 on the mesh bracket 143 may be adjusted according to the requirements of a person skilled in the art. In addition, the mesh bracket 143 may also be omitted, and the second mesh 142 may be directly fixed on the housing wall of the housing 10 at the first pressure relief hole 104. For example, a side of the second mesh 142 away from or close to the first mesh 141 may be fixed on the housing wall of the housing 10 at the first pressure relief hole 104.

Referring to FIG. 4, the housing 10 further includes a fourth housing wall 1104 connecting the first housing wall 1101 and the second housing wall 1102. The fourth housing wall 1104 and the third housing wall 1103 may be disposed opposite to each other along the third direction Z.

In the wearing state, the fourth housing wall 1104 is disposed on a side of the housing 10 facing the head of the user along the third direction Z.

In some embodiments, the housing 10 may include a fifth housing wall 1105 and a sixth housing wall 1106 spaced apart along the second direction Y. The fifth housing wall 1105 and the sixth housing wall 1106 may both be connected to the first housing wall 1101, the second housing wall 1102, the third housing wall 1103, and the fourth housing wall 1104. Along the second direction Y, the fifth housing wall 1105 may be closer to the ear 200 compared with the sixth housing wall 1106. In some embodiments, the sound outlet hole 103 may be disposed in the fifth housing wall 1105.

In some embodiments, housing walls, such as the first housing wall 1101, the second housing wall 1102, the third housing wall 1103, the fourth housing wall 1104, the fifth housing wall 1105, and the sixth housing wall 1106 may enclose to form the housing 10.

In some embodiments, the first housing 11 may be formed by enclosing housing walls, such as the second housing wall 1102, the third housing wall 1103, the fourth housing wall 1104, and the sixth housing wall 1106. In some embodiments, the fifth housing wall 1105 may be separated from the housing 10 to form an independent structure, which may be referred to as a cover body 12. In some embodiments, the first housing wall 1101 may be separated from the housing 10 to form an independent structure, which may be referred to as a second housing 13. Therefore, in some embodiments, the housing 10 may include the first housing 11, the cover body 12, and the second housing 13. The first housing 11 may be connected to the cover body 12 along the second direction Y and may be connected to the second housing 13 along the first direction X. It should be understood that the cover body 12 and the second housing 13 may also be connected. An assembly manner of the first housing 11, the cover body 12, and the second housing 13 may facilitate assembly and processing of the housing 10.

In some embodiments, the first housing 11 may be formed by enclosing housing walls, such as the second housing wall 1102, the third housing wall 1103, the fourth housing wall 1104, the fifth housing wall 1105, and the sixth housing wall 1106. That is, the cover body 12 may also be a part of the first housing 11.

It is understandable that the first housing 11 may not be limited to housing walls, such as the second housing wall 1102, the third housing wall 1103, the fourth housing wall 1104, and the sixth housing wall 1106, and may also include others. It should be understood that the first housing 11 may also be a structure of other forms. The cover body 12 may not be limited to the fifth housing wall 1105 and may also include others. It should be understood that the cover body 12 may also be a structure of other forms. The second housing 13 may not be limited to the first housing wall 1101 and may also include others. It should be understood that the second housing 13 may also be a structure of other forms.

Referring to FIG. 4, the cover body 12 may cover an end face of the second housing wall 1102. At the same time, the cover body 12 may also cover end faces of housing walls, such as the first housing wall 1101, the third housing wall 1103, and the fourth housing wall 1104. It should be understood that the cover body 12 may also cover the second housing 13.

Referring to FIG. 21, a first limiting slot 106 is disposed on the first housing 11. The first limiting slot 106 may be configured to accommodate at least a portion of the mesh bracket 143, enabling installation of the second mesh 142 and the mesh bracket 143 on the first housing 11. In some embodiments, the mesh bracket 143 may be inserted into the first limiting slot 106 and fixed by connecting the first housing 11 and the second housing 13, thereby achieving assembly and fixation of the mesh bracket 143, facilitating assembly of the acoustic output device 100, and improving stability of connection of the mesh bracket 143 to the first housing 11.

Referring to FIG. 22, FIG. 22 is a schematic diagram illustrating cooperation between the second housing 13 and the mesh assembly 14 in FIG. 4. A second limiting slot 107 is disposed on the second housing 13. The second limiting slot 107 may be configured to accommodate at least a portion of the mesh bracket 143, enabling installation of the second mesh 142 and the mesh bracket 143 on the second housing 13. In some embodiments, the mesh bracket 143 may be inserted into the second limiting slot 107 and fixed by connecting the first housing 11 and the second housing 13, thereby achieving assembly and fixation of the mesh bracket 143, facilitating assembly of the acoustic output device 100, and improving stability of connection of the mesh bracket 143 to the second housing 13.

In some embodiments, at least one of the first limiting slot 106 or the second limiting slot 107 may be omitted.

In some embodiments, a direction in which the mesh bracket 143 is inserted into the first limiting slot 106 and/or the second limiting slot 107 may be consistent with the engagement direction of the first housing 11 and the second housing 13, which is beneficial for assembly and fixation of the mesh bracket 143, facilitates assembly of the acoustic output device 100, and improves stability of connection of the mesh bracket 143 to the first housing 11 and the second housing 13.

In some embodiments, the engagement direction of the first housing 11 and the second housing 13 may be the first direction X. It should be understood that the engagement direction may also be different from the first direction X.

Referring to FIG. 21, one end of the mesh bracket 143 may be inserted into the first limiting slot 106 of the first housing 11 along the engagement direction, which is beneficial for assembly and fixation of the mesh bracket 143, facilitates assembly of the acoustic output device 100, and improves stability of connection of the mesh bracket 143 to the first housing 11.

Referring to FIG. 22, one end of the mesh bracket 143 may be inserted into the second limiting slot 107 of the second housing 13 along the engagement direction, which is beneficial for assembly and fixation of the mesh bracket 143, facilitates assembly of the acoustic output device 100, and improves stability of connection of the mesh bracket 143 to the second housing 13.

In some embodiments, one end of the mesh bracket 143 may be inserted into the first limiting slot 106 of the first housing 11 along the engagement direction, and the other end of the mesh bracket 143 may be inserted into the second limiting slot 107 of the second housing 13 along the engagement direction, which is beneficial for assembly and fixation of the mesh bracket 143, facilitates assembly of the acoustic output device 100, and improves stability of connection of the mesh bracket 143 to the first housing 11 and the second housing 13.

Referring to FIG. 5, the first pressure relief hole 104 includes two sub-pressure relief holes, for example, a first sub-pressure relief hole 1041 and a second sub-pressure relief hole 1042. The first sub-pressure relief hole 1041 may be disposed in the first housing 11, and the second sub-pressure relief hole 1042 may be disposed in the second housing 13.

In some embodiments, in the third housing wall 1103, the first sub-pressure relief hole 1041 and the second sub-pressure relief hole 1042 may not be in communication with each other, which is beneficial for enhancing the structural strength of the housing 10 at the first pressure relief hole 104. It should be understood that in the third housing wall 1103, the first sub-pressure relief hole 1041 and the second sub-pressure relief hole 1042 may be in communication with each other.

In some embodiments, the first sub-pressure relief hole 1041 and the second sub-pressure relief hole 1042 may be in communication or not in communication in the housing 10.

Referring to FIG. 19, the mesh bracket 143 is provided with two sound-guiding windows spaced apart along the engagement direction, for example, a first sound-guiding window 1431 and a second sound-guiding window 1432. Compared with providing a single larger sound-guiding window on the mesh bracket 143, such an arrangement is beneficial for enhancing the structural strength of the mesh bracket 143 and reducing the risk of deformation or damage to the mesh bracket 143. The second mesh 142 may cover the first sound-guiding window 1431 and the second sound-guiding window 1432, and the second mesh 142 may be supported more stably by the mesh bracket 143.

Referring to FIG. 21, the first sound-guiding window 1431 may correspond to the first sub-pressure relief hole 1041. The air-conduction sound generated by the air-conduction vibrator 20 may be transmitted from the second acoustic chamber 202 to the first pressure relief hole 104 (e.g., the first sub-pressure relief hole 1041), and then transmitted from the first sound-guiding window 1431 and the first sub-pressure relief hole 1041 to the mesh holes 1411, and finally transmitted to the outside of the housing 10.

Referring to FIG. 22, the second sound-guiding window 1432 may correspond to the second sub-pressure relief hole 1042. The air-conduction sound generated by the air-conduction vibrator 20 may be transmitted from the second acoustic chamber 202 to the first pressure relief hole 104 (e.g., the second sub-pressure relief hole 1042), and then transmitted from the second sound-guiding window 1432 and the second sub-pressure relief hole 1042 to the mesh holes 1411, and finally transmitted to the outside of the housing 10.

Referring to FIG. 21, the first housing 11 is provided with a first stopping portion 1107. The first stopping portion 1107 may be connected to housing walls, such as the second housing wall 1102, the third housing wall 1103, and the sixth housing wall 1106. In some embodiments, the first stopping portion 1107 may be connected to housing walls, such as the second housing wall 1102, the third housing wall 1103, and the sixth housing wall 1106 to form the first limiting slot 106. Accordingly, when the mesh bracket 143 is inserted into the first limiting slot 106 of the first housing 11, the mesh bracket 143 may abut against housing walls, such as the second housing wall 1102, the third housing wall 1103, and the sixth housing wall 1106, and may also at least abut against inner wall surfaces of housing walls, such as the second housing wall 1102, the third housing wall 1103, and the sixth housing wall 1106. In some embodiments, the first stopping portion 1107 is disposed in the first housing 11, for example, disposed on inner sides of housing walls, such as the second housing wall 1102, the third housing wall 1103, and the sixth housing wall 1106. In some embodiments, the first stopping portion 1107 may not be connected to housing walls, such as the second housing wall 1102, the third housing wall 1103, and the sixth housing wall 1106 to form the first limiting slot 106, but may be located in the first limiting slot 106. In some embodiments, the first limiting slot 106 is formed on the first stopping portion 1107, and/or formed on housing walls, such as the second housing wall 1102, the third housing wall 1103, and the sixth housing wall 1106. In some embodiments, the first stopping portion 1107 is configured to connect to or abut against the mesh bracket 143, so that the mesh bracket 143 abuts against inner wall surfaces of housing walls.

It should be understood that the forming manner of the first limiting slot 106 is not limited to the manners listed herein.

Referring to FIG. 22, the second housing 13 is provided with a second stopping portion 1108. The second stopping portion 1108 may be connected to housing walls of the second housing 13, such as the first housing wall 1101. In some embodiments, the second stopping portion 1108 may be connected to housing walls of the second housing 13, such as the first housing wall 1101, to form the second limiting slot 107. Accordingly, when the mesh bracket 143 is inserted into the second limiting slot 107 of the second housing 13, the mesh bracket 143 may abut against housing walls of the second housing 13, such as the first housing wall 1101, and may also at least abut against inner wall surfaces of housing walls of the second housing 13, such as the first housing wall 1101. In some embodiments, the second stopping portion 1108 is disposed on an inner side of housing walls of the second housing 13, such as the first housing wall 1101. In some embodiments, when the mesh bracket 143 is inserted into the second limiting slot 107 of the second housing 13, the mesh bracket 143 may abut against housing walls, such as the second housing wall 1102, the third housing wall 1103, and the sixth housing wall 1106, and may also at least abut against inner wall surfaces of housing walls, such as the second housing wall 1102, the third housing wall 1103, and the sixth housing wall 1106. In some embodiments, the second stopping portion 1108 may not be connected to housing walls of the second housing 13, such as the first housing wall 1101, to form the second limiting slot 107, but may be located in the second limiting slot 107. In some embodiments, the second limiting slot 107 is formed on the second stopping portion 1108, and/or formed on housing walls of the second housing 13, such as the first housing wall 1101. In some embodiments, the second stopping portion 1108 is configured to connect to or abut against the mesh bracket 143, so that the mesh bracket 143 abuts against inner wall surfaces of housing walls.

It should be understood that the forming manner of the second limiting slot 107 is not limited to the manners listed herein.

It is understood that one of the two stopping portions (i.e., the first stopping portion 1107 and the second stopping portion 1108) may be omitted. In some embodiments, the two stopping portions (i.e., the first stopping portion 1107 and the second stopping portion 1108) are an integral structure. In some embodiments, the first stopping portion 1107 is formed on the second housing 13 and cooperates with the first housing 11. In some embodiments, the second stopping portion 1108 is formed on the first housing 11 and cooperates with the second housing 13.

Referring to FIG. 4, the housing 10 further includes a partition wall 111. The partition wall 111 is configured to partition an internal space of the housing 10 into a first accommodation cavity 101 and a second accommodation cavity 102 that are spaced apart from each other. After the internal space of the housing 10 is partitioned, different functions of the acoustic output device 100 may be arranged in separate zones, which improves space utilization and reduces mutual influence between different functional components. In some embodiments, the first accommodation cavity 101 and the second accommodation cavity 102 are arranged along the second direction Y, and the first accommodation cavity 101 is closer to the ear 200 compared with the second accommodation cavity 102. Accordingly, when the air-conduction vibrator 20 is disposed in the first accommodation cavity 101, a transmission path of sound generated by vibration of the air-conduction vibrator 20 may be shortened, and sound pressure level of the acoustic output device 100 may be improved.

In some embodiments, the sound outlet hole 103, the first pressure relief hole 104, and the second pressure relief hole 105 may be in communication with the first accommodation cavity 101.

In some embodiments, the first accommodation cavity 101 may be formed by enclosing the partition wall 111 and housing walls, such as the first housing wall 1101, the second housing wall 1102, the third housing wall 1103, the fourth housing wall 1104, and the fifth housing wall 1105.

In some embodiments, the first accommodation cavity 101 may be formed by enclosing the partition wall 111 and housing walls, such as the second housing wall 1102, the third housing wall 1103, the fourth housing wall 1104, and the fifth housing wall 1105.

In some embodiments, the first accommodation cavity 101 may be formed by connecting the first housing 11 and the cover body 12.

In some embodiments, the first housing 11 may include a first sub-accommodation cavity 1011, and the cover body 12 may include a second sub-accommodation cavity 1012. When the first housing 11 is connected to the cover body 12, the first sub-accommodation cavity 1011 and the second sub-accommodation cavity 1012 form the first accommodation cavity 101.

In some embodiments, the first acoustic chamber 201 and the second acoustic chamber 202 may be disposed in the first accommodation cavity 101. In some embodiments, the first acoustic chamber 201 is located on a side of the diaphragm 21 facing the fifth housing wall 1105, and the second acoustic chamber 202 is located on a side of the diaphragm 21 facing the partition wall 111.

In some embodiments, the second accommodation cavity 102 may be formed by enclosing the partition wall 111, the first housing wall 1101, the second housing wall 1102, the third housing wall 1103, the fourth housing wall 1104, and the sixth housing wall 1106.

In some embodiments, the second accommodation cavity 102 may be formed by connecting the first housing 11 and the second housing 13.

In some embodiments, the first housing 11 may include a third sub-accommodation cavity 1021, and the second housing 13 may include a fourth sub-accommodation cavity 1022. When the first housing 11 is connected to the second housing 13, the third sub-accommodation cavity 1021 and the fourth sub-accommodation cavity 1022 form the second accommodation cavity 102.

Referring to FIG. 4, the core assembly 1002 may further include a bone-conduction vibrator 30 disposed in the second accommodation cavity 102. The bone-conduction vibrator 30 may generate a bone-conduction sound. In some embodiments, the first housing wall 1101 may contact the facial skin in the facial region M, and accordingly, the bone-conduction vibrator 30 may drive a physical load (e.g., the first housing wall 1101, user tissue, bone, etc.) to generate a bone-conduction sound.

In the several embodiments provided in the present disclosure, it should be understood that the disclosed method and device may be implemented in other manners. As another example, the device embodiments described above are merely illustrative. For example, division of modules or units is merely a division of logical functions. In actual implementation, there may be other division manners. For example, multiple units or components may be combined or integrated into another system, or some features may be omitted or not executed.

Units described as separate components may or may not be physically separate. Components displayed as units may or may not be physical units, i.e., may be located in one place or distributed across multiple network units. Some or all of the units may be selected according to actual needs to achieve objectives of the embodiments of the present disclosure.

In addition, functional units in the various embodiments of the present disclosure may be integrated into one processing unit, or each unit may exist alone physically, or two or more units may be integrated into one unit. The integrated unit may be implemented in a form of hardware or in a form of a software functional unit.

The foregoing descriptions are merely specific implementation manners of the present disclosure, but are not intended to limit the protection scope of the present disclosure. Any equivalent structure or equivalent process transformation made by using the content of the specification and the accompanying drawings of the present disclosure, or direct or indirect application in other related technical fields, shall fall within the protection scope of the present disclosure.

1. An acoustic output device, comprising a housing and an air-conduction vibrator, wherein
the air-conduction vibrator is disposed in the housing;
the housing includes a first acoustic chamber and a second acoustic chamber, wherein the first acoustic chamber and the second acoustic chamber are located on two sides of a diaphragm of the air-conduction vibrator, respectively;
the housing is provided with a sound outlet hole and a first pressure relief hole, wherein the sound outlet hole is in communication with the first acoustic chamber, and the first pressure relief hole is in communication with the second acoustic chamber; and
the acoustic output device further comprises a first mesh and a second mesh, the first mesh and the second mesh both being connected to the housing and configured to cover the first pressure relief hole, wherein
along a propagation direction of an air-conduction sound generated by the air-conduction vibrator in the first pressure relief hole, the second mesh and the first mesh are arranged in sequence, and the first mesh is closer to an outer side of the housing compared with the second mesh; and
a minimum spacing between the first mesh and the second mesh is not less than 0.2 mm.

2. The acoustic output device of claim 1, wherein at least a portion of the first mesh is exposed to the outer side of the housing, and the second mesh is connected to an interior of the first pressure relief hole or an interior of the first acoustic chamber.

3. The acoustic output device of claim 2, wherein the acoustic output device further includes a mesh bracket, wherein the mesh bracket is disposed in the housing and is connected to the housing, and the second mesh is disposed on the mesh bracket.

4. The acoustic output device of claim 3, wherein the second mesh is disposed on a side of the mesh bracket away from the first mesh.

5. The acoustic output device of claim 3, wherein the housing includes a first housing and a second housing, and the first housing and the second housing are engaged with each other, wherein
an inner side of the first housing is provided with a first limiting slot, wherein along an engagement direction of the first housing and the second housing, at least a portion of the mesh bracket is inserted into the first limiting slot; and/or
an inner side of the second housing is provided with a second limiting slot, wherein along the engagement direction of the first housing and the second housing, and at least a portion of the mesh bracket is inserted into the second limiting slot.

6. The acoustic output device of claim 5, wherein along the engagement direction, one end of the mesh bracket is inserted into the first limiting slot, and the other end of the mesh bracket is inserted into the second limiting slot.

7. The acoustic output device of claim 6, wherein the first pressure relief hole includes two sub-pressure relief holes, wherein
one of the two sub-pressure relief holes is disposed in the first housing,
the other of the two sub-pressure relief holes is disposed in the second housing, and
the second mesh is configured to cover the two sub-pressure relief holes simultaneously.

8. The acoustic output device of claim 7, wherein the mesh bracket is provided with two sound-guiding windows, wherein the two sound-guiding windows are spaced apart along the engagement direction and are arranged corresponding to the two sub-pressure relief holes respectively, and the second mesh is configured to cover the two sound-guiding windows simultaneously.

9. The acoustic output device of claim 6, wherein the first housing and/or the second housing includes a housing wall and a stopping portion, wherein
the stopping portion is disposed on an inner side of the housing wall and is spaced apart from an inner wall surface of the housing wall;
the first limiting slot and/or the second limiting slot is located at the housing wall and the stopping portion; and
when the mesh bracket is inserted into the first limiting slot and/or the second limiting slot, the stopping portion is configured to connect the mesh bracket, so that the mesh bracket abuts against the inner wall surface of the housing wall.

10. The acoustic output device of claim 1, wherein the first mesh and the second mesh are stacked.

11. An acoustic output device, comprising a housing and an air-conduction vibrator, wherein
the air-conduction vibrator is disposed in the housing;
the housing includes a first acoustic chamber and a second acoustic chamber, wherein the first acoustic chamber and the second acoustic chamber are located on two sides of a diaphragm of the air-conduction vibrator, respectively;
the housing is provided with a sound outlet hole and a first pressure relief hole, wherein the sound outlet hole is in communication with the first acoustic chamber, and the first pressure relief hole is in communication with the second acoustic chamber; and
the acoustic output device further comprises a first mesh, the first mesh being connected to the housing and configured to cover the first pressure relief hole, wherein
the first mesh is provided with a plurality of mesh holes penetrating through the first mesh, each of at least a portion of the plurality of mesh holes forming a contour line on an outer surface of the first mesh; and
the contour line has a minimum circumscribed sphere, the minimum circumscribed sphere has a sphere center, and on at least a portion of a section of the contour line, a distance between a point on the contour line and the sphere center changes along a circumferential direction of the contour line.

12. The acoustic output device of claim 11, wherein in the same contour line, each side is in the same plane.

13. The acoustic output device of claim 11, wherein the contour line is a closed contour line.

14. (canceled)

15. The acoustic output device of claim 13, wherein a count of sides of the closed contour line is not greater than 6.

16. The acoustic output device of claim 11, wherein in the same contour line, among three sides connected in sequence, only a middle side among the three sides is a straight side or a curved side.

17. The acoustic output device of claim 11, wherein a diameter of the minimum circumscribed sphere is not less than 0.4 mm.

18. The acoustic output device of claim 11, wherein the plurality of mesh holes include a plurality of first mesh holes and a plurality of second mesh holes, wherein
each of at least a portion of the plurality of first mesh holes forms the contour line on the outer surface of the first mesh, and/or each of at least a portion of the plurality of second mesh holes forms the contour line on the outer surface of the first mesh; and
a diameter of the minimum circumscribed sphere corresponding to the first mesh hole is less than a diameter of the minimum circumscribed sphere corresponding to the second mesh hole.

19. The acoustic output device of claim 18, wherein the plurality of first mesh holes are arranged around a periphery of the plurality of second mesh holes.

20. The acoustic output device of claim 11, wherein on the outer surface of the first mesh, in a direction from an edge toward a center, a diameter of the minimum circumscribed sphere corresponding to a mesh hole closer to the center among two adjacent mesh holes is larger.

21. An acoustic output device, comprising a housing and an air-conduction vibrator, wherein
the air-conduction vibrator is disposed in the housing;
the housing includes a first acoustic chamber and a second acoustic chamber, wherein the first acoustic chamber and the second acoustic chamber are located on two sides of a diaphragm of the air-conduction vibrator, respectively;
the housing is provided with a sound outlet hole and a first pressure relief hole, wherein the sound outlet hole is in communication with the first acoustic chamber, and the first pressure relief hole is in communication with the second acoustic chamber; and
the acoustic output device further comprises a first mesh, the first mesh being connected to an outer side of the housing and configured to cover the first pressure relief hole, wherein the first mesh is provided with at least one water-blocking groove penetrating through the first mesh, and the water-blocking groove has a strip shape.

22-30. (canceled)
